(19) United States
(12) Patent Application Publication
(10) Pub. No.: US 2017/0210640 A1
(43) Pub. Date: Jul. 27, 2017

(54) SHREDDED ION EXCHANGE PAPER

(71) Applicant: Norman B. Rainer, Richmond, VA (US)

(72) Inventor: Norman B. Rainer, Richmond, VA (US)

(21) Appl. No.: 14/998,945

(22) Filed: Mar. 9, 2016

Related U.S. Application Data
(63) Continuation-in-part of application No. 14/998,586, filed on Jan. 27, 2016.

(51) Int. Cl. C02F 1/28; B01J 20/26

(52) U.S. Cl. CPC C02F 1/285; C02F 1/286; B01J 20/262

(57) ABSTRACT

Shreds of a treated cellulosic paper are randomly gathered as an aggregation which permits passage of water. The paper contains chemical functionality which selectively absorbs dissolved ionic metal species from water.

### RELATED APPLICATIONS

This application is a continuation-in part of U.S. patent application Ser. No. 14/998,586, filed Jan. 2, 2016, and further hereby incorporates herein by reference U.S. Provisional Application Ser. No. 62/282,934 filed Aug. 17, 2015.

### BACKGROUND OF THE INVENTION

1. Field of the Invention

This invention concerns a cellulosic paper product for the selective removal of dissolved ionic metal species from water, and the manner of producing and utilizing such product.

2. Description of the Prior Art

Because of natural geological factors or anthropogenic effects, most bodies of water will contain trace levels of ionically dissolved heavy metal species, typically mercury, lead, copper, cobalt, nickel, cadmium, chromium and zinc. Such species, generally at concentrations in the range of about 0.02 to 5 parts per million (ppm) are usually of toxicological concern. Of even greater concern are highly polluted industrial and municipal waste waters. The removal of such toxic species is generally complicated by the presence in the water of high concentrations of innocuous species such as sodium, potassium, magnesium, calcium, nitrate, sulfate, phosphate, and chloride.

An often employed approach for the remediation of such polluted waters involves the use of absorbents having selective affinity for said trace metal species. In such procedures, the water to be treated is usually caused to flow through a confined permeable bed of bead-form ion-exchange material, generally produced from chemically modified polystyrene. However, the bead-form products are expensive, and require emplacement within dedicated columns having associated pumping equipment. Furthermore, metal-saturated polystyrene beads produce volatile toxic condensed ring hydrocarbon species when disposed of by way of incineration.

The desirability of incorporating into cellulose substrates substances having selective ion-exchange properties has earlier been recognized. For example, U.S. Pat. No. 5,002,984 discloses the incorporation into a cellulose sponge of a copolymer produced by the thermally induced condensation reaction of nitrilotriacetic acid (NTA) with polyethyleneimine (PEI). The PEI contains recurring primary, secondary and tertiary amine groups in a chain structure, and is known to absorb metal cations by way of formation of coordination complexes with the amine groups. The aforesaid incorporation process introduces up to 65% by weight of copolymer into said sponge, causing stiffening of the treated sponge and loss of compressibility. If forceably compacted, the copolymer splits away from the sponge.

Similarly, U.S. Pat. No. 8,809,227 discloses incorporation of the same copolymer into a cotton terrycloth fabric. The resultant fabric product is extremely stiff, and although useful in small pieces, has lost the flexibility needed for use in certain filtration applications. The same copolymer, when applied to cellulose filter paper, causes the resultant treated paper to lose the porosity requisite for filtration operations. In general, said applications have produced deposits of copolymer which are not chemically bound to the cellulose substrate. As such, the gross physical properties of the substrate are significantly altered, and the copolymer content is removable by physical manipulation.

In still other ways, it has been sought to associate PEI with cellulosic substrates, either in a removable manner such as a processing aide, or chemically joined to the cellulose by way of special bonding agents. It should be noted however, that the mere application of PEI (having a pH of about 12.0), to paper, followed by heating, produces decomposition of the PEI, forming a useless black composition.

It is accordingly an object of the present invention to provide a product for the efficient selective removal of trace levels of dissolved metal species from water.

It is another object of this invention to provide a product of the aforesaid nature which can economically function in conventional equipment for water treatment

These objects and other objects and advantages of the invention will be apparent from the following description.

### SUMMARY OF THE INVENTION

This invention is based in part upon the discovery that papers having selective ion exchange properties by virtue of the process of parent application Ser. No. 14/998,586 can be shredded and formed into aggregations providing specialized performance in fixed bed absorption operations.

### DESCRIPTION OF THE PREFERRED EMBODIMENT

The process for producing the selective ion exchange paper employed in the present invention starts with the preparation of an aqueous treatment solution containing dissolved PEI. A preferred concentration of PEI in the solution is in the range of 2% to 8%, producing an initial solution pH of about 12. It has been found that concentrations below 2% yield inadequate ion exchange functionality in a cellulose paper substrate. At concentrations above about 8%, it has been found that most of the PEI remains unreacted, presumably because of an absence of accepting reactive sites remaining in the cellulose.

The PEI-containing treatment solution is then treated with a strong mineral acid, preferably HCl, to produce protonated PEI and consequent solution pH in the range of about 4.5 to 6.8. At pH levels above 6.8, the solution leads to instability in a subsequent thermal curing process. At pH levels below about 4.5, reaction with cellulose has been found to be inefficient.

In certain embodiments, an organic polycarboxylic acid may be dissolved into the treatment solution prior to said treatment with a mineral acid. The ultimate effect of the polycarboxylic acid is to cross link PEI chains attached to the cellulose to produce a stabilized add-on. When utilized, the amount of said polycarboxylic acid is preferably between about 20% and 70% of the weight of the PEI. Suitable polycarboxylic acids include adipic acid, citric acid and tartaric acid. A particularily preferred polycarboxylic acid is nitrilotriacetic acid (NTA), which augments the metal-holding capacity of the PEI by attachment of chelation groups. It has been discovered that, although NTA is insoluble in plain water, it surprisingly remains dissolved in the treatment solution even after said solution is acidified to pH levels below 7.0.

The aforesaid treatment solution is then applied to a substantially dry cellulosic paper in sheet form in a manner to achieve uniformity with minimal run-off. Preferred papers are those which are marketed as “paper towels”, having the ability to absorb at least twice their weight of water, and having a wet tear strength at least 20% of their dry tear strength. The solution-saturated paper is then subjected to a uniform heating operation. Heating temperatures in the range of 250° F. to 350° F. have been found suitable for time durations of about 60 to 15 minutes respectively. It is desirable, but not necessary to exclude oxygen from the space surrounding the treated paper during heating, preferably by employing a stream of nitrogen gas.

Following the aforesaid heat treatment, the treated paper product is washed with water to remove any unreacted substances. An alkaline compound, such as sodium hydroxide may be incorporated into the wash water to adjust the paper pH to about 7.0. If the paper is left in an acidic state, it will have preferential affinity for anionic species.

It is preferred that the washed and dried treated paper contain an add-on of between 5% and 30% (dry weight basis) of said PEI or PEI derivative. Such treated paper sheets are considered to be “precursor paper” for the purposes of this invention, and will have a total nitrogen content between about 0.4% and 5.0%, as measured via standard Kjeldahl analysis, method EPA 351.2 R2.0. The expression “PEI derivative” is intended to include protonated PEI, and PEI which has interacted with other species, most notably carboxylic acids. At add-on levels below 5%, the precursor paper is minimally effective for its intended ion exchange function. At add-ons above about 30%, the treated paper may contain PEI or PEI derivatives which are not chemically bound to the paper, and will leach out in the course of use.

The add-on level can be controlled by suitable variations in the concentration of the treatment solution and/or the amount of solution applied to the starting paper. It has been found that acceptable results are achieved only when the molecular weight of the PEI is above 2000, and preferably above 5000. The expression “chemically bound” is intended to denote covalent bond formation between otherwise separate molecules. The preferred papers to be treated in the aforesaid manner are produced from wood, as in a Kraft process. The starting paper is preferably in the form of a continuous length, such as a spirally wound roll, enabling the heating operation to be achieved by heated rollers or paired top and bottom rollers within an oven.

It has been found that paper sheets having been treated as described hereinabove have a 25% to 32% increase in lateral area, measured omnidirectionally.

The treated, sheet form precursor paper of this invention, and consequently its shredded form, collectively referred to herein as “the paper” have the ability to selectively absorb 60% to 90% of the dissolved cationic and anionic species it encounters within about 8 seconds. The specific rate of absorption is dependent upon the water temperature, pH, nature and concentration of the species sought, presence and concentration of interfering species, and the extent of contacting motion of the water with the treated paper. When saturated with selected absorbed species, the paper can hold between about 0.4% and 8.0% of its weight of absorbed species (dry weight basis). Expressed alternatively, the paper has an absorption capacity of about 1-2 milliequivalents (meq)/dry gram. For example, the paper can absorb about 3.6% by weight of Cu+2, which represents about 1 meq of Cu⁺² per dry gram of paper, plus 5% by weight of Hg⁺², which represents more than ½ meq of Hg⁺² per gram of said paper.

The aforesaid sheet form treated precursor paper is converted into the shredded format of the present invention by passage of said sheets through a multi-bladed cutting device. Preferred shreds will have an elongated configuration having a substantially uniform width between about 3 mm and 6 mm, and an average length between 0.5 inch and 1.5 inch. At lengths shorter than 0.5 inch, the resultant aggregation of shreds, as a fixed absorption bed, has been found to present undesirably high impedance to the passage of water. At shred lengths greater than 1.5 inch, the aggregation becomes non-uniform, permitting regions where water will bypass significant portions of the bed. In one embodiment, the shreds will be substantially flat. In an alternative embodiment, the shreds may have a textured configuration such as a V-shaped repeated crimp, produced by the shredding of correspondingly textured precursor sheets.

In a further embodiment, the shreds or precursor sheets having PEI or PEI-containing derivatives may be post-treated with carbon disulfide. Such treatment generates sulfur species such as thiourea and dithiocarbamate groups chemically bound to the paper, which enhance ion exchange performance. The extent of such treatment is preferably such as to cause the thus treated precursor paper to have a total elemental sulfur content between about 0.2% and 4.0%. Said post treatment is preferably carried out by exposing moistened precursor sheets to vapor phase CS₂.

In a still further embodiment, stiffening shreds may be blended into the aggregation of the shredded paper so as to increase the crush resistance of the aggregation. Preferably, such stiffening shreds are pieces of shredded plastic film having dimensions similar to the shredded paper, and employed in amounts representing about 1% to 15% by weight of the aggregate. Suitable films include unplasticised PVC at thicknesses of 6-8 mils. Such stiffening shreds can be produced and blended with the paper shreds at the cutting apparatus that creates the shreds.

A further understanding of my invention will be had from a consideration of the following examples which illustrate certain preferred embodiments. It is to be understood that the instant invention is not to be construed as being limited by said examples or by the details therein.

### EXAMPLE 1

An aqueous solution was made containing 4% by weight of PEI having a molecular weight of 10,000. (The PEI is a product of Nippon Shokubai of Japan). NTA was then added in an amount representing a 2% concentration in the solution. The solution was then titrated to pH 5.5 with conc. HCl. The resultant solution, considered a protonated PEI treatment solution, was applied to Viva™ absorbent toweling paper, arranged in strip form, to cause thorough soaking without run-off. The Viva™ starting paper is capable of absorbing an amount of water about 3.2 times its dry weight, and has a wet tear strength of 0.24 pounds, which is about 60% of its dry tear strength of 0.40 pounds.

The soaked paper was then oven-treated at 320° F. for 45 minutes, then spray-washed with water having a pH of 8.0, and dried. The resultant treated paper has an add-on weight of PEI derivative of 19%, with substantially unchanged water uptake and wet tear strength. By way of Kjeldahl analysis, the paper was found to contain 0.5% nitrogen. Said resultant precursor paper was fed into a commonplace office shredding machine having cross-cut features. An aggregation of pieces of shredded paper was thereby produced, said pieces having an average length of about 1.5 inch and reasonably consistent width of about 3.5 mm.

### EXAMPLE 2

In a laboratory scale test aimed at characterizing the bulk properties of the aggregation of shreds of Example 1, 6.16 grams of said shreds, having an air-equilibrated moisture content of 6.5% were entered into a vertically supported clear plastic tube having an inside diameter of 1.5 inch, height of 27 inches, and a bottom stopper equipped with a flow control stopcock.

The shreds, having initially formed a loose aggregation at the bottom of the tube, were then compacted with a force of 325 grams using a plunger rod, resulting in a compacted bed having a height of 3.75 inch and representing a bed volume of 6.6 cubic inches (or 108 cc). Water was flowed through the bed from a constantly maintained height of 21 inches above the top of the compacted bed. The unrestricted flow rate through the bed was found to be 190 cc/min. This represents a contact time of the water with the bed of 34 seconds (based upon empty bed volume). Slower flow rates were achievable by way of stopcock restriction of exit flow or greater compaction of the bed.

### EXAMPLE 3

A test solution containing approximately 40 ppm concentrations each of copper, zinc, mercury, and lead in their chloride forms, plus 1% each of sodium and calcium chlorides was run , at gravity force, through the compacted bed of Example 2 at a rate to provide a 45 second contact time. A blue/black absorption band formed atop the bed (and representing only about 8 seconds of contact time) and descended the bed. The effluent water emergent from the bed, upon testing, showed a 94% reduction in copper concentration, and reductions of 78%, 86% and 89% of zinc, mercury and lead, respectively. The sodium and calcium concentrations were unchanged, thereby illustrating the ionic selectivity of the shreds. A sample of the uppermost portion of the absorption band, presumably representing a saturated state, was taken for analysis, and found to contain 1.4% copper, 1.2% zinc, 2.3% mercury, and 1.6% lead.

### EXAMPLE 4

About 30 grams of shreds produced in the manner of Example 1 were adjusted to a moisture content of 15% and placed upon an apertured shelf horizontally positioned at mid-height of a sealable plastic box. About 3 cc of CS₂ were added to the bottom of the box, and the box was sealed for two hours at a temperature of 60° F. Upon opening the box, little CS₂ odor could be detected. The shreds were washed in water, dried and subjected to elemental analysis, whereupon the shreds were found to contain 1.3% sulphur. When tested for absorption properties using the test solution and procedure of Example 3, it was found that all the heavy metal species were reduced to non-detect levels. This substantiates the use of CS₂ treatment to enhance the metal absorption properties of the shreds.

### EXAMPLE 5

In separate experiments, the wash water employed in Example 1 was caused to contain 0.2%-0.3% levels (solids basis) of bonding agents such as polymer latex or Resole resin which are water miscible (generically, water-soluble or water-dispersible) products, but which, upon drying become insoluble while causing interadherance of adjacent structure. The paper sheets thus treated were then dried using enmeshing corrugated heated rollers. The resultant sheets, having somewhat stiffened characteristics and a pattern of parallel elongated upraised peaks, were then fed into a shredding machine in a direction such that the cutting blades of the shredding machine are orthogonal to the sequential line of peaks. In this manner, the resultant shreds have a non-flat, texturized elongated contour.

When such texturized shreds were tested for bed compaction by the technique of Example 1, it was found that the compacted bed had a volume increase of about 20%. This means that, on an industrial basis, where beds of immense size may be utilized, beds of aggregates of texturized shreds of the present invention may be employed in a manner which permits high throughput while employing gravity flow (as in a river). Specific bonding agents include Vycar™ 351 of the Lubrizol Company and Resole , available from the Georgia-Pacific Company. In an alternative but equivalent method for texturizing a sheet of treated paper prior to cutting, the paper sheet, in a damp state can be squeezed in a stuffer box, causing a sawtooth, or zigzag crimping effect which can be locked in place by heating.

### EXAMPLE 6

An amount of shreds produced as in Example 1 were blended with stiffening shreds of unplasticized PVC (polyvinylchloride) of 7 mil thickness and having a length of about 1 inch, and width of 3 mm. The blending was achieved by alternatingly running paper and plastic sheets through a single shredding machine, then tumbling the mixture. The amounts of the PVC shreds were varied in separate experiments between 1% and 10% by weight of the mixture. Employing the bed-forming technique of Example 1 with 6.16 grams of the blended mixture of shreds, the following results were obtained

| Weight % of Stiffening Shreds | % increase in bed volume |
|---|---|
| 1% | 10% |
| 5% | 20% |
| 10% | 35% |

The increased volumes of the beds produce consequent rapid flows through the beds at any specific degree of bed compaction.

While particular examples of the present invention have been shown and described, it is apparent that changes and modifications may be made therein without departing from the invention in its broadest aspects. The aim of the appended claims, therefore, is to cover all such changes and modifications as fall within the true spirit and scope of the invention

Having thus described my invention, what is claimed is:

1) An aggregation of randomly oriented shreds of paper, said shreds having an average length between 0.5 and 2.0 inches and width between 2 to 6 mm, said paper containing 5% to 30% by weight of PEI or derivatives thereof, causing said paper to have an elemental nitrogen content between 0.4% and 5.0% and having the capability of selectively absorbing dissolved ionic toxic heavy metal species at trace concentrations from water having an abundance of dissolved innocuous ions, the capacity of said absorption being at least 1 meq of heavy metals per dry gram of paper .

2) The aggregation of claim 1 wherein the amount of absorptive capacity specifically for copper is at least 2% per dry gram of said shreds.

3) The aggregation of claim 2 wherein said PEI derivative is the reaction product of PEI with a polycarboxylic acid.

4) The aggregation of claim 3 wherein said polycarboxylic acid is NTA.

5) The aggregation of claim 1 having admixed therewith shreds of plastic material which serve to increase the resistance of said aggregation to volumetric compaction by way of compressive force.

6) The aggregation of claim 5 wherein said shreds of plastic material have physical dimensions similar to the dimensions of said paper shreds within said aggregation.

7) The aggregation of claim 6 wherein said shreds of stiffening material have a thickness between 5 and 8 mils.

8) The aggregation of claim 1 wherein said paper has been reacted with carbon disulfide, causing said shreds to have organically bound sulphur to an extent having a sulphur content between 0.2% and 4.0%.

9) The aggregation of claim 8 wherein said shreds have been produced by way of contact with vapor phase carbon disulfide.

10) The aggregation of claim 1 in the form of a compacted bed having the ability to absorb within about 8 seconds at least 90% of dissolved ionic heavy metal species from water passing through said bed.

11) The aggregation of shreds of claim 1 wherein said shreds have a texturized configuration wherein the long direction of the shreds is non-flat.

12) The aggregation of shreds of claim 1 confined as a fixed bed within a receptacle adapted to receive a through-going flow of water.
